(19) United States
(12) Patent Application Publication
(10) Pub. No.: US 2008/0087857 A1
(43) Pub. Date: Apr. 17, 2008

(54) Valve Apparatus

(76) Inventor: Massimiliano Pineschi, Villanova(MO) (IT)

Correspondence Address: COLLARD & ROE, P.C., 1077 NORTHERN BOULEVARD, ROSLYN, NY, 11576, US

(21) Appl. No.: 11/793,300

(22) PCT Filed: Dec. 20, 2005
(86) PCT No.: PCT/EP05/13713

§ 371 Date: Jun. 19, 2007

(30) Foreign Application Priority Data
Dec. 22, 2004 (IT) MO 2004 A 000341

(51) Int. Cl. F16K 31/02

(52) U.S. Cl. 251/129.08; 417/28

(57) ABSTRACT

The valve apparatus comprises a container body (2) defining in the inside thereof chamber means (3); inlet means (4) in the chamber means (3) of a fluid having an operating pressure value (Pi) supplied by supplying means (9) and outlet means (6) of the fluid from the chamber means (3); controlling means (10) of the outlet means (6), in the container body (2) arrest means for arresting the supplying means (9) being provided when the fluid reaches a present maximum operating pressure value (P2) that is greater than the operating value (P1).

The present invention relates to a valve apparatus.

All apparatuses that produce steam, regardless of the use for which they are intended, are provided with a source of steam, specifically a boiler or a generator, that supplies steam upon command to be used for sterilising, producing drinks using lyophilised wafers, or for cleaning surfaces.

The steam is created by a boiler that is supplied from the electricity supplied from a conventional domestic or industrial mains electricity supply to which it is connected by means of a power cable.

The boiler is located inside the apparatus that produces steam, together with a tank or refillable cistern for containing the water required for generating the steam and which are connected to the boiler by means of a connecting pipe.

The steam is conveyed in a pipe that is connected to the boiler by means of a sealed joint the opposite end of which faces the exterior.

This opposite end is provided with means suitable for controlling the emission of jets of steam, like, for example, a switch that is pressed by a user whenever the latter wishes to make a jet of steam leave the nozzle and which is released when the jet has to be interrupted.

This switch controls a solenoid valve that is mounted along a steam passage circuit, more precisely between the boiler and the pipe connection; the solenoid valve is provided with an inlet for the steam that comes from the boiler through the passage circuit and with an outlet thereof to the nozzle of the pipe.

The outlet is controlled by a shutter that opens it or shuts it according to the commands transmitted by the user to the switch or by software managing the apparatus that contains the boiler.

In practice, the steam goes into the solenoid valve through the inlet of the latter and fills a containing space provided for that purpose in the valve body and which is also connected to the outlet.

The shutter, which is made of metal material and is surrounded by an electromagnet, is normally kept in a closing position of the outlet until steam is requested: in this case, the electromagnet is activated and makes the shutter move by lifting it from the outlet, which thus opens, enabling the steam to pass through and move to the outlet nozzle of the pipe.

In order to operate in safe conditions, the boilers are provided with instruments for measuring and keeping under control the pressure and temperature of the steam therein; these instruments are called pressure switches and thermostats respectively and at the moment in which the steam reaches pressure or temperature values that are so high as to become dangerous both for the integrity of the apparatus that contains the boiler and for the safety of the users, they are able to interrupt the electric supply of the heating members of the boilers automatically: in this way, the production of steam is interrupted and pressure stops increasing; the pressure is successively decreased by discharging the steam both through special vent devices which are foreseen in the boilers, and simply by acting on the switch and making a continuous jet of steam leave the nozzle until pressure has returned to normal operating values.

This prior art has some drawbacks.

A first drawback is that both the pressure switches and the thermostats are mounted on the boilers in positions that are separate from the solenoid valves that control the supplying of the jets of steam; therefore, in order to use the steam and to keep the apparatuses in a safe condition, two or more safety devices are required that are distinct from one another.

A second drawback is that having to mount two or more elements that are distinct from one another onto boilers, i.e. one or more solenoid valves, a safety thermostat, a pressure switch, is a constraint on designers in making bodies of apparatuses that produce steam: the shapes are therefore greatly influenced by the presence of these elements that are distinct from one another and are necessary for functioning; owing to this, the shapes often appear to be stylistically unpleasing because they are conditioned by these needs to provide two or more distinct housings for housing as many distinct elements: designers cannot in effect create shapes solely dictated by their fancy and, above all, by the pleasure of customers, and this negatively influences the marketability of apparatuses that produce steam, especially if such apparatuses are household appliances.

A third drawback is that known pressure switches and thermostats have an intervention limit which is preset and which is not modifiable; in other words, for each tolerable maximum pressure, or temperature, value, a suitable pressure switch or a suitable thermostat must be mounted that has a preset and fixed intervention limit value, that is the same as or lower than the maximum tolerable value, interrupting the boiler supply when this maximum tolerable value has been reached.

The object of the present invention is to improve the prior art.

An object of the invention is to make a valve apparatus that does not place stylistic constraints on the creation of apparatuses that produce steam.

Another object of the invention is to make a valve apparatus that is able to interrupt the production of steam in the boilers that in general use it, according to modifiable pressure limits.

According to an aspect of the invention a valve apparatus is provided comprising: a container body defining chamber means in the inside thereof; inlet means in said chamber means of a fluid having an operating pressure value, supplied by supplying means and outlet means of said fluid from said chamber means; controlling means of said outlet means, characterised in that in said container body arresting means is provided for arresting said supplying means when said fluid reaches a preset maximum operating pressure value that is greater than said operating pressure value.

According to another aspect of the invention a detecting apparatus of pressure values is provided comprising: chamber means provided with inlet means of a fluid having an operating pressure value and being supplied by supplying means, and outlet means of said fluid; arresting means of said supplying means when the pressure of said fluid reaches preset maximum values; detecting means of said preset maximum pressure values movably supported in said chamber means for a portion defined between a rest position far from said arresting means and an activating position in contact with said arresting means, characterised in that between said detecting means and said arresting means selecting means is interposed for selecting said maximum pressure values.

The valve apparatus thus enables both the functions of dispensing jets of steam on command and automatic interruption of the production of steam when the pressures of the latter reach limit values, to be grouped into a single substantially compact element; the detecting apparatus furthermore enables the pressure limit values at which steam production has to be interrupted to be selected according to need.

Further features and advantages of the invention will become clearer from the detailed disclosure of a valve apparatus, illustrated by way of non-limitative example in the attached tables of drawings, in which:

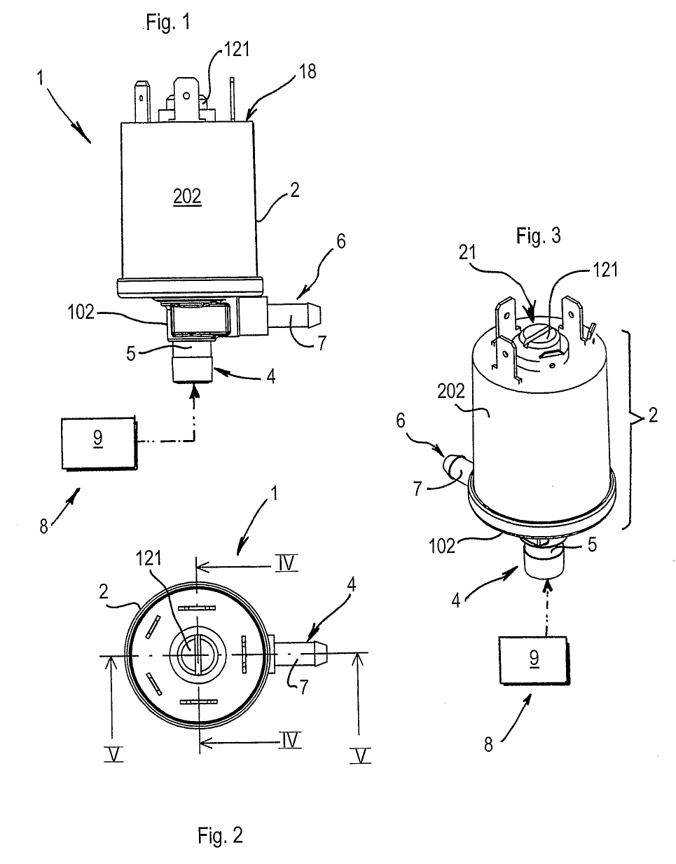

FIG. 1 is a side view of a valve apparatus;

FIG. 2 is the view from above of the valve apparatus in FIG. 1;

FIG. 3 is a perspective view of the valve apparatus in FIG. 1;

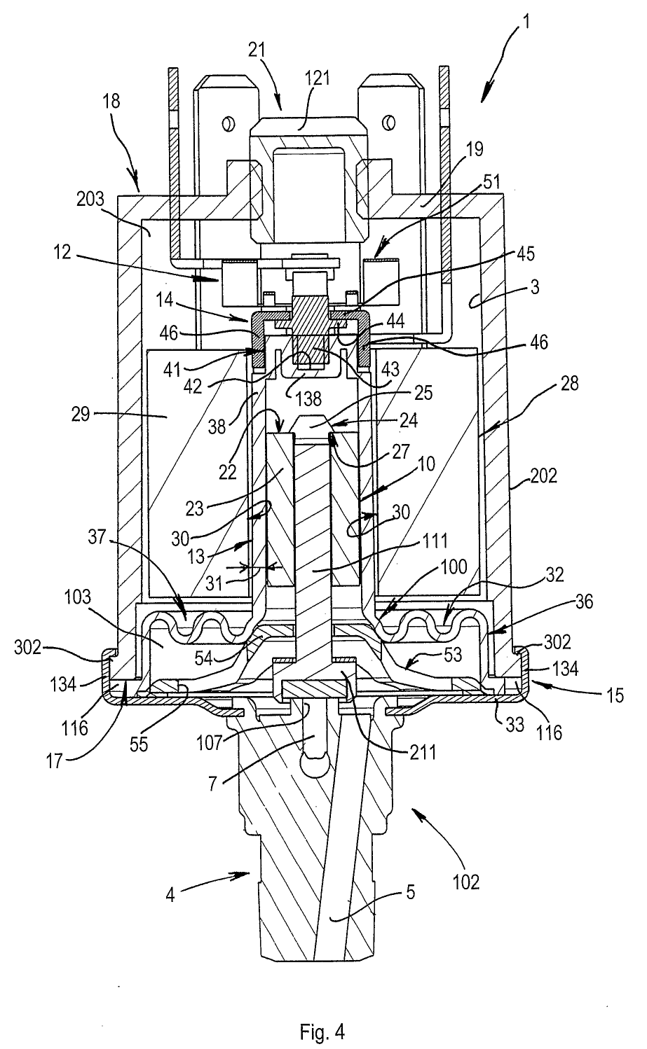

FIG. 4 is a section of the valve apparatus in FIG. 1 taken along a plane IV-IV;

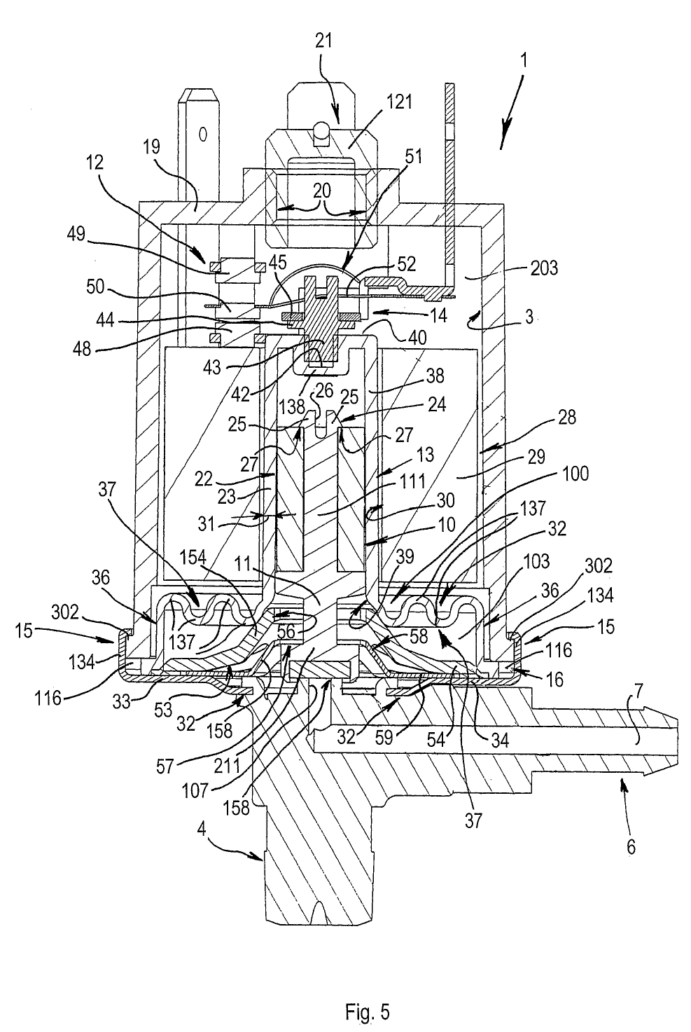

FIG. 5 is a section view of the valve apparatus in FIG. 1 taken along a plane V-V.

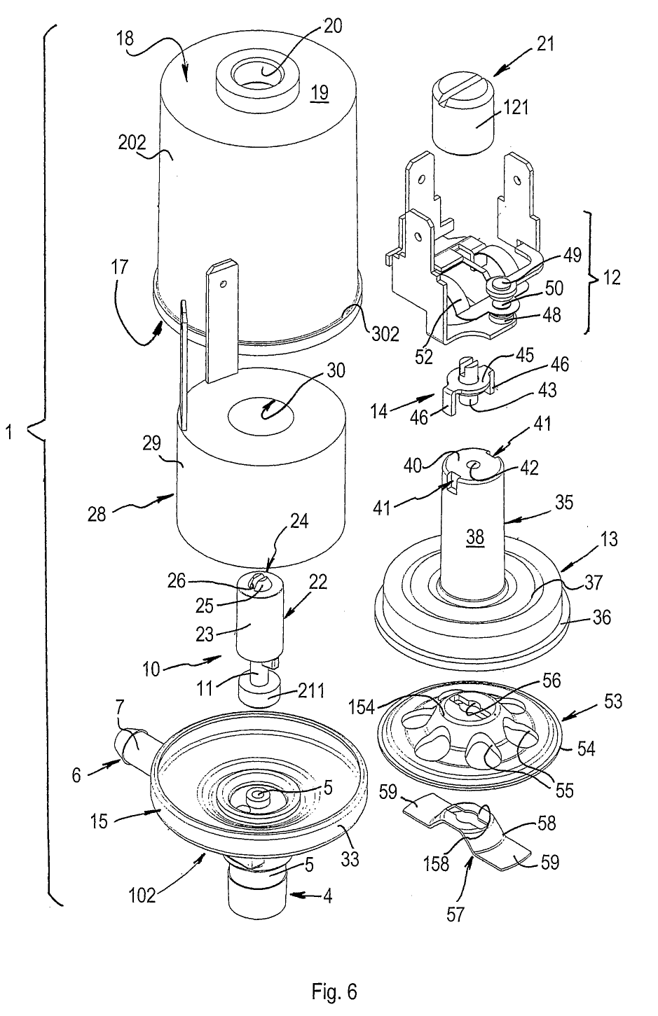

FIG. 6 is an exploded view of the valve apparatus in FIG. 1.

With reference to FIG. 1, 1 indicates a valve apparatus that comprises assembling means 200 comprising a container body 2 that defines chamber means 3 therein.

The chamber means 3 is provided with inlet means 4, for example a first conduit 5, and with outlet means 6, for example a second conduit 7.

Through the first conduit 5 pressurised fluid, in the case in point, steam, enters the chamber means 3 at operating pressure P1 and generated by supplying means 8, like a boiler 9.

The second conduit 7 is controlled by controlling means 10 that comprises a shutter member 11, disclosed more fully below.

The valve apparatus 1 furthermore comprises arresting means 12, for arresting the operation of the supplying means 8 when the steam reaches a maximum pressure P2 that is much greater than operating pressure P1.

The arresting means 12 is activated by means of a detecting apparatus 100 that is located inside the chamber means (3) and comprises detecting means 13; the latter detects pressure increases beyond the operating pressure value P1 up to a presettable maximum pressure P2: for this reason the detecting means 13 comprises selecting means 14 to be able to select at will the values of said maximum pressures P2; when the steam reaches these maximum pressures P2, the detecting means 13 activates the arresting means 12.

The container body 2 comprises a base 102 and a concave casing 202 shaped as a cylindrical glass and coupled with the base 102 by coupling means 15; between the concave casing 202 and the coupling means 15, seal means 16 is provided, for example an annular gasket 116.

The concave casing 202 has a first open end 17 facing the base 102 and an opposite end 18 that is closed by a closing wall 19.

The chamber means 3 can thus be defined between the base 102 and the inside of the concave casing 202.

The closing wall 19 has an opening 20, that is normally centred, that is occludable by a corresponding cap 21 and through which it is possible to access the inside of the chamber means 3.

The occlusion of the opening 20 by means of the cap 121 occurs by screwing the latter into the opening 20 and for this reason both are provided with reciprocally engageable threads.

Inside the chamber means 3 the shutter member 11 is mounted that comprises a stem body 111 and a head 211 placed aligned on the second conduit 7, more precisely on the mouth 107 of the latter.

The stem body 111 is enclosed by casing means 22 comprising a cylinder 23 in magnetic material that is axially crossed by a cavity 123 in which the stem body 111 is fitted and which is arrested in this position by anti-disengaging means 24.

The latter comprises a pair of flexible elements 25 that extend parallel from an end of the stem body 111 opposite that of the head 211 and which are separated by a notch 26 and which respectively have ends provided with teeth 27 suitable for engaging in one direction with the edges of the cavity 123.

Inside the chamber means 3 actuating means 28 is also located, for moving the shutter member 11 from a closing position to an opening position of the second conduit 7 and vice versa.

The actuating means 28 comprises a solenoid unit 29 that surrounds the cylinder 23 and has an axial opening 30 having a diameter that is greater than the diameter of the cylinder 23, so as to define a circular gap 31 between the latter and the walls of the axial opening 30.

The solenoid unit 29 occupies axially a portion of the chamber means 3, more precisely a substantially central portion: at the ends of the chamber means 3 two small chambers 103 and 203 thus remain defined, the small chamber 103 of which is defined between the base 102 and the solenoid unit 29 and the small chamber 203 of which are defined between the latter and the closing wall 19.

The base 102 is fixed to the concave casing 202 by the coupling means 15, which comprises a collar 33, that has a substantially flat portion 34 that is integrally coupled with the base 102, for example by means of a slot, and a peripheral portion 134, that is folded on an external peripheral edge 302 of the concave casing 102.

Inside the first small chamber 103 detecting means 32 is placed to detect the pressure of the fluid that traverses said first small chamber 103, to activate arresting means 33 of the boiler 9 when the fluid reaches a maximum operating pressure value P2 that is much greater than a normal operating value P1 and therefore when abnormal hazard conditions for user safety occur.

The detecting means 13 comprises a membrane member 35 that is shaped for forming a circular plate 36 provided with flexible means 37 and with a cylindrical element 38 that extends integrally from the plate 36 and is suitable for being arranged inside the circular space 31, containing within itself the shutter member 11 and the cylinder 23 in magnetic material and being arranged parallel between the latter and the walls of the axial opening 30.

The cylindrical element 38 is substantially rigid and has an end 39 open and communicating with the small chamber 103 and an opposite closed end 40 closed with a bottom 138.

This opposite end 40 has a pair of notches 41 on the outside that are diametrically opposed to one another and extend in length parallel to one another and to a longitudinal axis of the cylindrical element 38, for a portion along the external surface of the latter and the function of which is better disclosed below.

The bottom 138 of the opposite end 40 has a portion that is centrally recessed that defines a hollowed seat 42 in which the selecting means 14 is engageable.

The latter comprises a screw element 43 that is engageable in the hollowed seat 42 which, for this reason, is provided with an internal thread, having, for example, a micrometric pitch.

The screw element 43 has a perimeter collar 44; on the screw element 43 a further collar 46 is fitted in such a way as to rest on the perimeter collar 44 and which is provided with two segments 47 folded parallel to one another and to the longitudinal axis of the cylindrical element 38, to be able to couple slidingly in the notches 41 and avoid accidental rotations of the further collar 46 with respect to the cylindrical element 38.

By screwing or unscrewing the screw element 43 the latter is moved axially with respect to the cylindrical element 38, in the direction of the closing wall 19 or in the opposite direction.

Inside the small chamber 203 the arresting means 12 is located that comprises a pair of electric contacts 48 and 49 that are linked respectively to a supply cable of the boiler 9 and a supply cable of an alarm device.

Between the contacts 48 and 49 a further contact 50 is provided to which an electric supply cable is linked that comes from a normal main domestic supply, that is supported on support switching means 51; the latter comprises an elastic and flexible lamina 52 that is suitable for keeping the further contact 50 normally connected together with the contact 48, thus supplying an electric supply to the boiler 9.

In the first small chamber 103 in which the base 36 of the membrane member 35 is located, limit switch means 53 is also mounted concentrically to the latter, to stop axial movements of the shutter member 11 and which is positioned between the flexible means 37 and the base 102.

This means 53 comprises, as visible in FIGS. 3, 4, 5, a disc 54 that has the central portion 154 shaping a raised zone facing the open end 39 of the cylindrical element 38.

The disc 54 furthermore has a series of openings 55 that are obtained in the surface thereof, to enable the passage of fluid, and a central opening 56 for the passage of the stem body 111 of the shutter member 11.

The height of the central portion 154 determines the size of the stroke of the shutter member 11.

Coaxially to the latter, and interposed between the disc 54 and the base 102, elastic recall means 57 is provided for recalling the shutter member 11 to a normal closing position of the second conduit 7.

The elastic recall means 57 comprises a flat spring 58 that also has a raised central portion 158 and has a hole centred like the central portion 154, to enable the stem body 111 of the shutter member 11 pass through and that forms two diametrically opposite wings 59 that extend outwards; the wings 59 are kept pressed against the base 102 by the disc 54 inside the perimeter of the plate 36.

The flexible means 37 comprises un series of concentric circular folds 137 that have an undulating cross section and that make the membrane member 35 elastically flexible, enabling movements of the cylindrical element 38 in the direction of the closing wall 19.

The operation of the valve apparatus is as follows: in conditions of normal use, i.e. when the steam that is produced by the boiler 9 has an operating pressure that has a normal operating pressure value P1, the pressurised fluid, in the case in point steam, runs along the first inlet conduit 5 and enters inside the first small chamber 103.

The shutter member 11 is kept in the normal closing position of the second outlet conduit 7 by the flat spring 58 that presses thereupon with the central portion 158 thereof and for this reason the steam cannot exit through the second conduit 7 until the user runs a command that activates the solenoid unit 29.

The actuation of the latter creates a magnetic field that acts on the cylinder 23 made with magnetic material and moves it together with the shutter member 11 in the direction of the closing wall 19, overcoming the recall action of the flat spring 58.

Moving the shutter member 11 opens the second outlet conduit 7 and the steam flows out of the valve apparatus 1, for example to a nozzle from which it is projected outside.

If during use of the valve apparatus 1 a hazard condition occurs, i.e. an anomalous and progressive increase of the operating pressure value, this pressure increase also extends inside the first small chamber 103, causing a thrust on the membrane member 35, which flexes progressively in the direction of the closing wall 19; this flexure is permitted by the flexible means 37, i.e. by the concentric circular folds 137 that are deformed elastically stressed by the thrust of the pressurised steam.

This flexure causes the axial movement in the same direction as the cylindrical element 38 that runs inside the circular gap 31 defined between the cylinder 23 and the solenoid unit 29 for a portion defined between the detecting apparatus 100 and the arresting means 12, i.e. more precisely, between the bottom 138 and the elastic sheet 52.

This sliding brings the screw element 43 into contact with the elastic sheet 52, which is progressively lifted from its normal position in which it keeps the further contact 50 connected to the contact 48 connected to the boiler 9; this instantaneously interrupts the power supply to the boiler 9 and causes the arrest of the latter, which stops producing steam, interrupting each further increase of steam pressure. The position of the screw element 43 is determined beforehand to enable the intervention of the arresting means 12 at a preset and selected maximum pressure value P2 by screwing or unscrewing the screw element 43 in the hollowed seat 42 and then modifying the movement portion of the cylindrical element 38.

In detail, screwing determines a raising of the intervention limit of the arresting means 12, as the movement portion along which the cylindrical element 38 has to travel to bring the screw element 43 into contact with the lamina 52 increases whereas the opposite happens if the screw element 43 is unscrewed.

As steam pressure does not decrease instantaneously with the interruption to the supply to the boiler 9, the cylindrical element 38 continues to move for a further small portion and the elastic sheet 52 pushed by the screw element 43 makes the further contact 50 connect with the contact 49, to which an alarm device of optical or acoustic type is normally connected that issues a hazard signal that is perceptible by the user.

The latter can therefore run the commands that cause opening of the second outlet conduit 7 and discharge the steam contained in the chamber means 3, or more precisely in the small chamber 103, outside the valve apparatus 1, rapidly decreasing the pressure therein until it returns to normal values near to normal operating pressure P1 or until steam pressure is discharged completely.

It is known that the size of the stroke that the shutter member 11 can perform when steam is requested by the user, and therefore when the solenoid unit 29 is activated, is determined by the size of the height of the central portion 154 of the disc 54; in fact, the shutter member 11 moves axially in the direction of the closing wall 19 until the head 211 abuts on the face of the central portion 154 of the disc 54 facing it.

1. Valve apparatus (1) comprising: chamber means (3) provided with inlet means (4) of a fluid having an operating pressure value (P1), supplied by supplying means (9) and outlet means (6) of said fluid; controlling means (10) of said outlet means (6), wherein arresting means (12) is provided for arresting said supplying means (9) when said fluid reaches a preset maximum pressure value (P2) that is greater than said operating value (P1); assembling means (200) for assembling said controlling means (10) with said arresting means (12).

2. Valve apparatus (1) according to claim 1 wherein said assembling means (200) comprises a container body (2) defining in the inside thereof said chamber means (3).

3. Valve apparatus (1) according to claim 1 wherein between said arresting means (12) and said outlet means (6) there is interposed detecting means (13) of pressure values preset to activate said arresting means (12).

4. Valve apparatus (1) according to claim 1 wherein said detecting means (13) is provided with selecting means (14) for setting said preset maximum values (P2).

5. Valve apparatus (1) according to claim 1 wherein said controlling means (10) comprises a shutter member (11) placed inside said chamber means (3) and driven by actuating means (28).

6. Valve apparatus (1) according to claim 5 wherein said shutter member (11) comprises a stem body (111) facing said actuating means (28) and a head (211) placed at an end of said stem body (111), facing said outlet means (6) and aligned on the latter, at least said stem body (111) being made of magnetic material.

7. Valve apparatus (1) according to claim 5 wherein said shutter member (11) comprises a stem body (111) and a head (211) that is placed at an end of said stem body (111), facing said outlet means (6) and aligned on the latter, cylinder means (23) made of magnetic material encasing said stem body (111) being provided for.

8. Valve apparatus (1) according to claim 5 wherein said actuating means (28) comprises a solenoid unit (29) that is housed in said chamber means (3) and coaxially surrounds said stem body (111).

9. Valve apparatus (1) according to claim 6 wherein between said stem body (111) and said solenoid unit (29) or between said cylinder means (23) and said solenoid unit (29) a cylindrical running gap (31) is defined.

10. Valve apparatus (1) according to claim 1 wherein said arresting means (12) comprises: at least a pair of electric contacts (48, 49) located inside said chamber means (3) and provided with extending means extending outside said container body (2), to a first contact (48) respective supply cable means of said supply members (9) being linked to a second contact (49) being linked to supply cable means of an alarm device; a further contact (50) to which there is linked electric cable means originating from a source; support switching means (51) for supporting said further contact (50).

11. Valve apparatus (1) according to claim 10 wherein said support switching means (51) comprises an elastic and flexible lamina (5.2) that is suitable for keeping normally connected together said further contact (50) and said first contact (48).

12. Valve apparatus according to claim 3 wherein said detecting means (13) comprises: a membrane member (35) that forms a circular plate (36) provided with flexible means (37); a cylindrical element (38) that extends from said plate (36) orthogonally thereto and integrally therewith, slidable in said cylindrical space (31), having an open end (39) and an opposite closed end (40) with a bottom (138) arranged to come into contact with said elastic lamina (52) and lift it up, causing the detachment of said further contact (50) from said first contact (48).

13. Valve apparatus (1) according to claim 12 wherein said flexible means (37) comprises a series of circular folds (137) that are concentric with respect to one another and to said cylinder element (38), that are obtained in said circular plate (36) and having an undulating cross section.

14. Valve apparatus (1) according to claim 1 wherein said container body (2), shutter member (11), solenoid unit (29), cylindrical element (38) are coaxial to one another.

15. Valve apparatus (1) according to claim wherein said container body (2) comprises: a base (102); a box element (202) coupled to said base (102) by coupling means (15) and having a first coupling end (17) facing said base (102) and an opposite second end (18).

16. Valve apparatus (1) according to claim 15 wherein said first end (17) is open and said second end (18) has a closing wall (19).

17. Valve apparatus (1) according to claim 16 wherein said closing wall (19) has a through opening (20) provided with coupling means with shutter means.

18. Valve apparatus (1) according to claim 17 wherein said coupling means comprises a thread obtained in the walls of said through opening (20).

19. Valve apparatus (1) according to claim 17 wherein said shutter means comprises a cap member (121) provided with a threaded shank engageable in said thread.

20. Valve apparatus (1) according to claim 1 wherein said chamber means (3) is divided by said solenoid unit (29) into a first small chamber (103) defined between said solenoid unit (29) and said base (102) and a second small chamber (203) defined between said solenoid unit (29) and said closing wall (19).

21. Valve apparatus (1) according to claim 1 wherein said inlet means (4) and said outlet means (6) are obtained in said base (102).

22. Valve apparatus (1) according to claim 15 wherein said coupling means (15) comprises a collar (33) that has a substantially flat portion (34) that is integrally coupled with said base (102), and a peripheral portion (134) that is folded to overcome an external peripheral edge (302) of said concave casing (102).

23. Valve apparatus (1) according to claim 22 wherein between said external peripheral edge (302) and peripheral portion (134) there is provided sealing means (16).

24. Valve apparatus (1) according to claim 1 wherein within said first small chamber (103) there is housed opening limit switch means (53) of said shutter member (11).

25. Valve apparatus (1) according to claim 24 wherein said limit switch means (53) comprises a disc (54) that has a central portion (154) shaping a raised zone facing said open end (39) of said cylindrical element (38).

26. Valve apparatus (1) according to claim 25 wherein said disc (54) has a series of openings (55) that are obtained in the surface thereof to enable the passage of fluid and a central opening (56) for the passage of said stem body (111).

27. Valve apparatus (1) according to claim 1 wherein between said head (211) and said disc (54) there is arranged elastic recall means (57) of said shutter member (111) in closing position of said first conduit (5).

28. Valve apparatus (1) according to claim 27 wherein said elastic recall means (57) comprises a flat spring (58) having a raised central portion (158) traversed by a central hole for the passage of said stem body (111) and suitable for remaining resting on said head (211), pushing it against said conduit (5).

29. Valve apparatus (1) according to claim 28 wherein said flat spring (28) forms at least two diametrically opposite wings (59) that extend outwards, said wings (59) being pressed against said base (102) by said disc (54) within said plate (36).

30. Detecting apparatus (100) of pressure values comprising: chamber means (3) provided with inlet means (4) of a fluid having an operating pressure value (P1) and supplied by supplying means (9), and outlet means (6) of said fluid; arresting means (12) of said supplying means (9) when the pressure of said fluid reaches preset maximum pressure values (P2); detecting means (13) of said preset maximum pressure values (P2) movably supported in said chamber means (3) for a portion defined between a rest position far from said arresting means (12) and an activating position in contact with said arresting means (12), wherein between said detecting means (13) and said arresting means (12) selecting means (14) is interposed for selecting said preset maximum pressure values (P2).

31. Detecting apparatus (100) according to claim 30 wherein said selecting means (14) comprises: screw means (43); a hollowed and threaded seat (42) obtained in said detecting means (13) and facing said arresting means (12) and in which said screw means (43) is engageable, the screwing or unscrewing of the latter modifying said portion.

32. User device provided with steam producing means wherein it comprises a valve apparatus (1) according to claim 1.

33. User device provided with steam producing means wherein it comprises a detecting apparatus (100) according to claim 30.

34. User device provided with steam producing means wherein it comprises a valve apparatus (1) according to claim 1 and a detecting apparatus (100) for a valve 31.
